(19) United States
(12) Patent Application Publication
(10) Pub. No.: US 2026/0118592 A1
(43) Pub. Date: Apr. 30, 2026

(54) OPEN RACK NODE-TO-NODE COMMUNICATION VIA A LOW-COST OPTICAL BUS

(71) Applicant: DELL PRODUCTS L.P., Round Rock, TX (US)

(72) Inventors: Michael Stumpf, Cedar Park, TX (US); Sandor Farkas, Round Rock, TX (US); Kevin Mundt, Livingston, TX (US)

(21) Appl. No.: 18/929,772

(22) Filed: Oct. 29, 2024

(51) Int. Cl. G02B 6/38; G02B 6/02; G02B 6/42

(52) U.S. Cl. CPC G02B 6/38; G02B 6/02033; G02B 6/4277

(57) ABSTRACT

An information handling system may include an optical bus system for managing nodes. The optical bus system may include a plastic optical fiber configured to transmit light signals between the nodes. The plastic optical fiber includes a plurality of molded notches positioned at predetermined intervals along a length of the plastic optical fiber. Each of the plurality of molded notches is configured to allow light ingress into and light egress from the plastic optical fiber for multi-node communication.

### FIELD OF THE DISCLOSURE

The present disclosure generally relates to information handling systems and, more particularly, relates to an optical bus system for multi-node communication within a server rack.

### BACKGROUND

As the value and use of information continue to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use, such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system may include an optical bus system for managing individual servers or nodes. The optical bus system may include a plastic optical fiber with molded notches that are positioned at predetermined intervals (e.g., every 1OU) of the plastic optical fiber to allow light ingress and egress. The light may include modulated light rays from a repurposed optical light system (OLS) and/or system identifier light emitting diode (ID LED) of each node in a rack. The molded notches may communicatively interconnect these nodes by allowing the propagation of the modulated light rays. By leveraging the new communication capabilities of the repurposed OLS and/or system ID LED and the structure of the optical bus system, the modulated light rays that carry data can be efficiently coupled into and out of the plastic optical fiber. Further, the use of a spread spectrum and error correction codes may provide multi-node communication and data integrity for the node-to-node communication.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIGS. 1-2 are diagrams of an information handling system according to at least one embodiment of the present disclosure;

FIGS. 3-5 are diagrams of node-to-node communications according to at least one embodiment of the present disclosure;

FIG. 6 is a diagram of a data transmission in a node-to-node communication according to at least one embodiment of the present disclosure;

FIG. 7 is a diagram of a color correcting process according to at least one embodiment of the present disclosure;

FIG. 8 is a diagram of synchronizing transmitting and receiving nodes according to at least one embodiment of the present disclosure;

FIG. 9 is a flow diagram of a method for data transmission in a node-to-node communication according to at least one embodiment of the present disclosure; and

FIG. 10 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

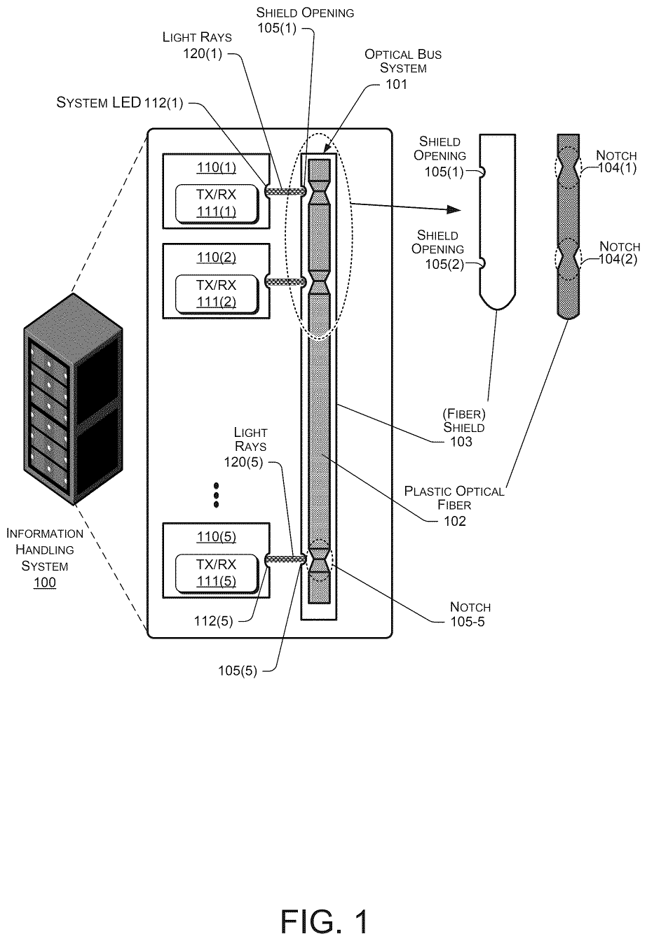

FIG. 1 illustrates an information handling system 100 including an optical bus system 101 for multi-node communications, according to at least one embodiment of the present disclosure. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, the information handling system 100 may represent a computer system, such as a laptop computer, a desktop computer, a computer workstation, a server system, a blade server system, or other rack-mounted computer equipment, such as a storage server, a network server, a network switch/router, or other datacenter computer equipment, or other electronic equipment generally defined, but being characterized as including the optical bus system 101 that facilitates multi-node communications between components 110(1)-110(5).

In a particular embodiment, the optical bus system 101 may include a (Polymethyl Methacrylate) PMMA plastic optical fiber 102 that can be (optionally) enclosed within a protective shield 103 to block ambient light. The PMMA plastic optical fiber 102 may include molded notches 104(1)-104(5) at predetermined intervals along a length of the plastic optical fiber to allow ingress and egress of light rays 120(1)-120(5). System LEDs 112(1)-112(5) may include the OLS and/or system ID LEDs that were repurposed for transmitting and/or detecting modulated light signals, e.g., light rays 120(1)-120(5). By leveraging the new capabilities of the repurposed OLS and/or system ID LEDs and designing the optical bus system 101 with flexibility in terms of notch assignment to different nodes or components of the rack, the optical bus system 101 may reduce complexity while maintaining full access across the ORv3 structure.

As shown, the components 110(1)-110(5) may include corresponding transceivers TX/RX 111(1)-111(5) and system LEDs 112(1)-112(5), which can respectively emit light rays 120(1)-120(5). The optical bus system 101 may include the PMMA plastic optical fiber 102 that can receive the light rays 120(1)-120(5). The optical bus system 101 may also include the shield 103 with shield openings 105(1)-105(5) that can allow ingress or egress of the corresponding light rays 120(1)-120(5) from the molded notches 104(1)-104(5). The light rays 120(1)-120(5) may include modulated signals that can facilitate the optical node-to-node communications between the components 110(1)-110(5) as may be needed or desired. In an implementation, the system LEDs 112(1)-112(5), the shield openings 105(1)-105(5), and the molded notches 104(1)-104(5) are respectively aligned together to allow the light ingress into and light egress from the PMMA plastic optical fiber 102.

Nodes or components 110(1)-110(5) may include hardware components or computing units that work together to process or store data. For example, the component can be a processor, memory, storage, power supply unit (PSU), and the like, that can be positioned at different levels of the rack. Depending upon the physical locations of these nodes (or components) and system requirements, the optical bus system 101 may interconnect a portion or all of the nodes for node-to-node communication. The physical location includes specific positioning of the component in the rack, while system requirements may include data rate requirements, distance requirements, security, and/or the presence of high ambient light conditions. The optical bus system 101 can be attached to a busbar support (not shown) to communicatively interconnect the components 110(1)-110(5).

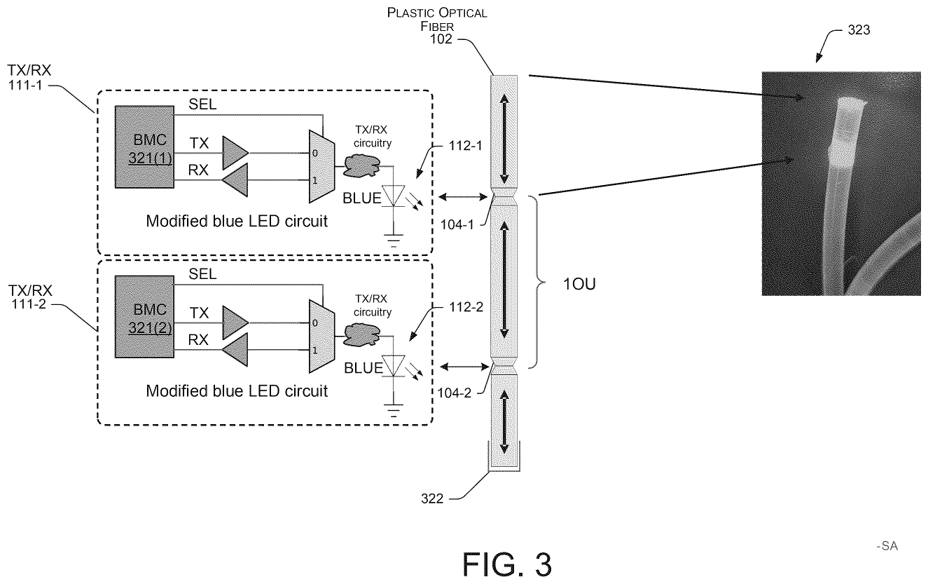

TX/RX 111(1)-111(5) may include devices that can transmit and/or receive modulated light signals through the PMMA plastic optical fiber 102. These devices may enable bi-directional communication between the nodes, allowing the components 110(1)-110(5) to send and receive data through the same PMMA plastic optical fiber 102. At transmit mode, the TX/RX 111(1) may convert electrical signals into modulated light signals that can be propagated through the PMMA plastic optical fiber 102. For example, the TX/RX 111(1) may utilize pulse width modulation (PWM) techniques on a repurposed LED to generate modulated light rays 120(1) that can carry data from the component 110(1). Here, the TX/RX 111(1) may control the electric power that is fed to the repurposed LED by adjusting a duty cycle (or ON-time) of a current pulse in relation to a cycle time. At receive mode, the TX/RX 111(1) may receive modulated light signals and convert the received modulated light signals into electrical signals. For example, the TX/RX 111(1) may use a repurposed LED with photodiode capability to detect the incoming light rays 120 from the PMMA plastic optical fiber 102. As further discussed in FIGS. 3-5, the TX/RX 111(1)-111(5) may include corresponding controllers (BMCs) that can be reconfigured to support the new capabilities of the repurposed OLS and/or system ID LEDs.

System LEDs 112(1)-112(5) may include the OLS and/or system ID LEDs (not shown) that were repurposed to act as a transmitter (TX) and/or receiver (RX) of optical signals. The repurposing is not limited to reconfiguring the functions of the OLS and/or system ID LEDs but may also include replacing and/or adding ultraviolet (UV) LEDs, RGB (Red, Green, Blue) LEDs, and the like to existing OLS of the components. For example, blue colored—system ID LEDs can be reconfigured to receive modulated light signals because these types of LEDs are effective in rejecting ambient light during the receive mode. The RGB LEDs may be reconfigured to transmit data over different colors or wavelengths simultaneously, increasing data throughput. LEDs with photodiode capabilities can be reconfigured to act as dedicated light signal detectors. The high-intensity LEDs that emit stronger light signals can be reconfigured for transmitting data over longer distances with minimal losses, and ultraviolet (UV) LEDs that can generate high energy but at a shorter wavelength can be reconfigured for precise transmission or reception of data. Further, the laser diodes can be reconfigured for high-data-rate transmission due to their more focused and coherent light, and so on. Here, the optical bus system 101 may use dedicated plastic optical fibers to connect a portion or all of the nodes as may be needed or desired.

In some embodiments, the system LEDs 112(1)-112(5) may provide frequency modulated or intensity modulated light rays 120 to transmit the identification or other data from one node to another node. Here, the transceivers TX/RX 111(1)-111(5) and the system LEDs 112(1)-112(5) may be configured to perform half-duplex or full-duplex communications. Although illustrated separately in FIG. 1, the system LEDs 112(1)-112(5) can be integrated with the corresponding transceivers TX/RX 111(1)-111(5) to perform the node-to-node communication.

Optical bus system 101 may include a structure that implements data communication between multiple nodes (servers or components) using the optical signals instead of electrical signals. The optical bus system 101 may serve as a shared communication channel within the ORv3 structure, allowing the components 110(1)-110(5) to send and receive data efficiently across a single optical pathway, such as the PMMA plastic optical fiber 102. Here, the PMMA plastic optical fiber 102 may be used to transmit data in the form of light pulses, such as intensity modulated (PWM) light pulses to encode data.

In an embodiment, the optical bus system 101 may utilize the structure of the PMMA plastic optical fiber 102 and the shield 103 to implement the optical coupling between the components 110(1)-110(5). For example, the component 110(1) can use the system LED 112(1) to transmit data via the modulated light rays 120(1). Here, the system LED 112(1) is aligned or substantially aligned with the shield opening 105(1) and the notch 104(1) to allow propagation of the modulated light rays 120(1) in the PMMA plastic optical fiber 102. In another example, the component 110(2) can use the system LED 112(2) to detect and receive the modulated light rays 120(2). Here, the system LED 112(2) can include a photodiode that is aligned or substantially aligned with the shield opening 105(2) and the notch 104(2) to receive the modulated light rays 120(2).

Notches 104 may include grooves or modifications that are positioned along predetermined intervals (e.g., every 1OU) of the length of the PMMA plastic optical fiber 102 to enable light ingress (entry) and egress (exit). These grooves may serve as light coupling points to enable the light ingress and egress, allowing the transmission and reception of the light signals between the nodes.

In some embodiments, the predetermined intervals may correspond to the physical layout and communication requirements of the information handling system 100. For example, in the ORv3 rack or other similar systems, the nodes (components 110) are spaced by 1OU. In a case where the system requirement includes all of the nodes to be connected together, then the notches 104 can be positioned at intervals corresponding to 1OU to allow each node to have access to the optical bus system 101 at its respective position. In some cases, only a portion of the total number of nodes is designated to perform the node-to-node communication. Here, the predetermined intervals may be based upon the physical location or specific placement of the communicating nodes in the ORv3 rack.

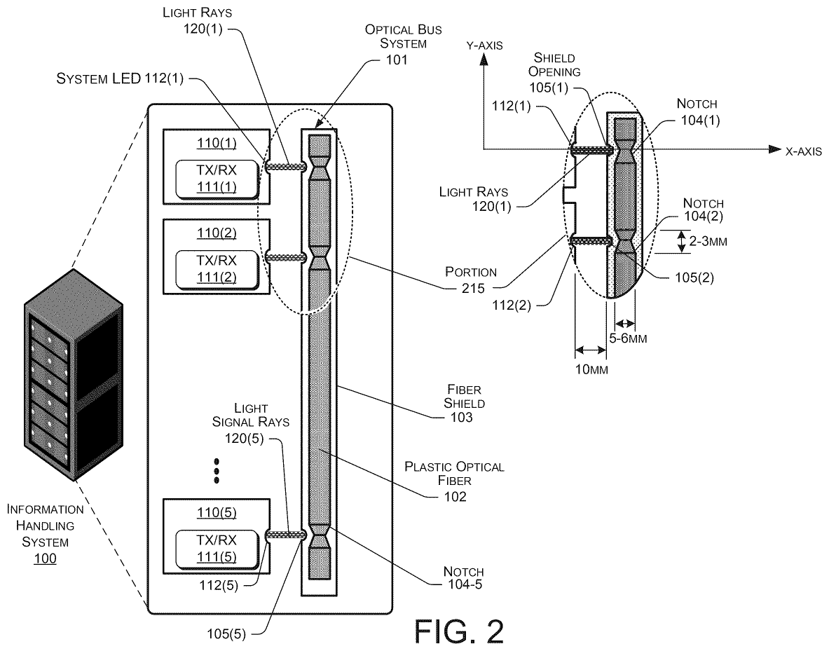

As further described in FIG. 2, the notches 104 may include particular dimensions to allow the light ingress and egress for the node-to-node communication.

Shield 103 may include a protective enclosure to cover and surround the PMMA plastic optical fiber 102 while selectively allowing the modulated light rays 120 to enter and exit through the shield openings 105. The optional shield 103 may block ambient light and external interference from affecting the modulated light rays 120 that are being propagated through the shield openings and the PMMA plastic optical fiber 102 to ensure reliable data communication between nodes. For example, the shield 103 may include an opaque casing that prevents external light sources from interfering with the modulated light signals traveling inside the PMMA plastic optical fiber 102. This opaque casing ensures that only the intended modulated light signals are coupled into and out of the PMMA plastic optical fiber 102 via the shield openings 105, maintaining the integrity of the optical communication.

In a particular embodiment, the shield 103 may include shield openings 104 at predetermined intervals along the length of the shield for light ingress and/or egress from the corresponding molded notches 104. The shield openings 104 may include cutouts or slots that are concentrically aligned with the corresponding notches 104 in the PMMA plastic optical fiber 102, allowing the necessary light signals to enter and exit at the desired points. The shield openings 104 may include circular apertures that allow the communication signals to travel in and out of the PMMA plastic optical fiber at each node.

In some embodiments, each circular aperture of the shield opening 105(1)-105(5) may include a minimum diameter that allows the light to exit from the PMMA plastic optical fiber 102 to ensure that the receiving node can detect the light rays 120 with minimal loss. For example, a circular shield opening includes a diameter that matches a diameter of the PMMA plastic optical fiber 102 to provide enough clearance for the light ingress and egress. Further, the length of the circular shield opening (circular aperture) may be configured to be deep enough to expose the entire notched area of the PMMA plastic optical fiber 102.

Light rays 120 may serve as a medium for transmitting data between the nodes, such as between the components 110(1)-110(5). As described in the system LED 112 above, the light rays 120 may be injected into or extracted from the PMMA plastic optical fiber 102 via the notches 104, enabling node-to-node communications. The light rays 120 can include different colors or wavelengths, such as red, green, and blue (RGB), which allow for multi-channel communication via the PMMA plastic optical fiber 102. Here, the choice of colors may enable data multiplexing by encoding different streams of data into different colors of light. For example, the light intensity of the system LED 112 can be modulated (PWM) to encode multiple bits of data using the brightness and colors of the RGB light.

In an embodiment, the components 110(1)-110(5) may include controllers (not shown) such as Baseboard Management Controllers (BMCs) that can be configured to support the new capabilities of the repurposed OLS in the component. For example, the formed system LED 112(1) can now transmit modulated light rays 120(1) instead of just conveying a power ON or OFF status in a prior configuration. In this example, and depending upon the type of modulation to be used, the controllers may be configured to toggle the mode of using the system LED 112(1). Further, the controllers may set the system LED's behavior to transmit data in a controlled and reliable manner using different modulation schemes.

For example, in a pulse width modulation (PWM) scheme, the controller may control the brightness of the Red (R), Green (G), and Blue (B) color channels by adjusting the corresponding duty cycle of the driving electric power. Here, the combination of the brightness levels of the Red, Green, and Blue LEDs creates a point in a 3D color space. Each unique combination of red, green, and blue brightness corresponds to a different color and intensity, which can represent a particular data symbol. For example, the controller may set the Red LED to 70%, Green LED to 50%, and Blue LED to 30% brightness to represent one unique data symbol. In this example, the combination of the settings of the red, green, and blue LEDs may generate a PWM signal (or data signal) that is representative of the unique data symbol to be transmitted.

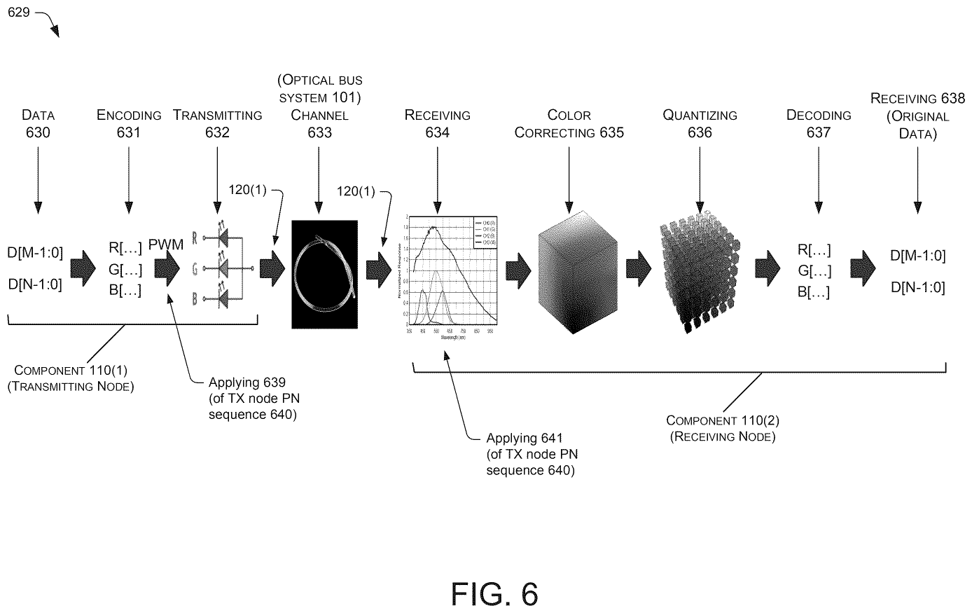

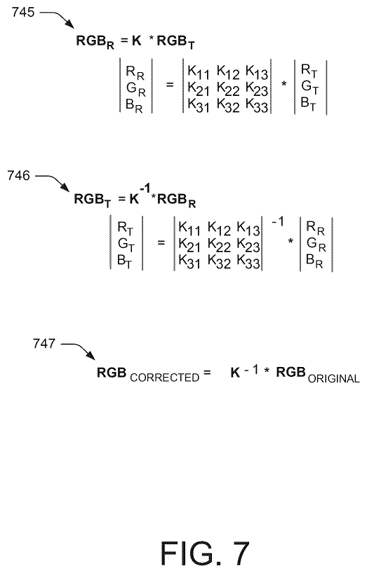

In some embodiments, the controller may further apply a pseudo-random noise (PN) sequence to the PWM signal (or data signal) to generate a spread spectrum signal (also referred to herein as modulated signal). The spread spectrum signal may be generated by the application of the PN sequence to modify the timing or width of each pulse in the PWM signal and accordingly distribute the PWM signal across a wider spectrum. The spread spectrum signal may cause the light rays 120 to be transmitted across a broader frequency range, making the modulated signal more resistant to noise and interference. At the receiving node, the modulated signal is despread using the same PN sequence that was used to modulate the PWM signal. Here, the receiver controller is configured to store the PN sequences from each node and utilize the corresponding PN sequence to recover the data signal. As further described in FIGS. 6-7 below, each node may be associated with a unique identifier (e.g., different PN sequences) to distinguish one node from another node.

The controller may also be configured to support the deployment of error correction codes encoding to minimize the effects of ambient light interference or electrical noise. The error correction codes may introduce, for example, redundancy into the transmitted data by adding extra bits that can be used to detect and correct errors. Here, the controller, for example, may check for errors by comparing the received bits with an expected pattern. If an error is detected, then the controller may correct the error based on the redundant bits. The error correction codes may be implemented over different types of modulations of the light rays 120 as may be needed or desired.

FIG. 2 illustrates an information handling system 100, according to at least one embodiment of the present disclosure. As shown, a portion 215 (dotted circle) includes a cutout of the components 110(1)-110(2) and the optical bus system 101. In this illustration, the position or location of the system LED 112(1) may be aligned horizontally (as shown by the x-y axis) with the shield opening 105(1) and the notch 104(1), which can be shaped as a lens. The shield opening 105(1) includes a cutout (circular aperture) that allows the intended modulated light signals (light rays 120(1)) to be coupled into and out of the PMMA plastic optical fiber 102 via the notch 104(1). Similarly, the position or location of the system LED 112(2) may be aligned horizontally (as shown by the x-y axis) with the shield opening 105(2) and the notch 104(2). The shield opening 105(2) may allow the intended modulated light signals, such as the light rays 120(2) that pass through and out of the PMMA plastic optical fiber 102 via the notch 104(2). In these cases, the dimensions of the shield openings 105 can be matched with the dimensions of the PMMA plastic optical fiber 102 and the notches 104.

For example, the PMMA plastic optical fiber 102 has a diameter of 5-6 mm. The shield opening 105(1) may substantially match the diameter of the PMMA plastic optical fiber 102 to provide enough clearance for the light rays 120(1) to pass through and for the notched section (with the shape of a lens) to remain exposed for the modulated light signal ingress and egress. In this example, for a 6 mm PMMA plastic optical fiber 102, the diameter of the shield opening 105(1) is about 6.5 to 7 mm to allow a slight margin for installation flexibility while minimizing gaps to block the ambient light from entering the notch 104(1).

Following the above example, the length of the shield opening 105(1) can be about 2-3 mm to expose the entire area of the lens shaped notch 104(1) in the PMMA plastic optical fiber 102. A 3 mm shield opening length, for example, may allow adequate light transmission through the notch 104(1) while keeping the rest of the PMMA plastic optical fiber 102 enclosed to protect against the ambient light interference.

The dimensions of the notch 104(1) may also be structured to allow enough light to exit the PMMA plastic optical fiber 102 without causing significant signal loss or disrupting total internal reflection within the PMMA plastic optical fiber. For example, for the 5-6 mm PMMA plastic optical fiber diameter, a notch depth of about 0.8 mm may allow enough light to enter or exit. The notch angle and the notch width may further include configurations to ensure that the light injected into the PMMA plastic optical fiber 102 is guided along the plastic fiber via internal reflection, while also allowing modulated light signals to exit at other notches for detection by other nodes.

In some embodiments, contactless node-to-node communication may include a gap of 10 mm (or lower than 10 mm) between the system LEDs 112 and the shield openings 105 of the optical bus system 101. In some cases, the gap may allow minimal unwanted ambient lights into the PMMA plastic optical fiber 102. However, the controller may be configured to employ the error correction codes or the spread spectrum encoding to minimize the effects of ambient light interference or electrical noise.

FIG. 3 illustrates an example of node-to-node communication, according to at least one embodiment of the present disclosure. In an embodiment, a single LED, such as an existing blue colored-system ID LED with photodiode capability, can be repurposed for half-duplex communication. Here, the controllers, such as BMCs 321(1)-321(2) in respective TX/RX 111(1)-111(2), may be reconfigured to manage the new capabilities of the repurposed blue-colored system ID LEDs (system LED 112(1)-112(2)).

For example, when the TX/RX 111(1) utilizes the system LED 112-1 for transmission of data, the BMC 321(1) may select the transmit mode (binary 0) to perform the half-duplex node-to-node communication. On the other hand, when the system LED 112-1 is used for receiving data, the BMC 321(1) may select the receive mode (binary 1) to receive the modulated light rays from the PMMA plastic optical fiber 102. In some embodiments, the BMC 321 may utilize Code Division Multiple Access (CDMA) for multiple nodes to share the same communication channel during the half-duplex node-to-node communication. The CDMA may allow the different TX/RX to share the same frequency band simultaneously.

As shown, the notches 104-1 and 104-2 are positioned at every 1OU of the ORv3 rack. However, the positioning of the notches 104-1 and 104-2 at predetermined intervals can be based upon the physical layout and system requirements as described herein. For example, the location of the blue colored-system ID LED is not uniform for different types of components. Here, the positioning of the notches 104 at predetermined intervals is customized as may be needed or desired. In another example, only a portion of the components having laser diodes can transmit or receive high bandwidth data transfers. Here, the positioning of the notches 104 at predetermined intervals is also customized as may be needed or desired.

In some embodiments, an additional metal cap 322 may be placed at each end of the PMMA plastic optical fiber 102 to reflect the signals and minimize signal losses. Illustration 323 of FIG. 3 shows one end of a deployed PMMA plastic optical fiber 102 with the additional metal cap 322.

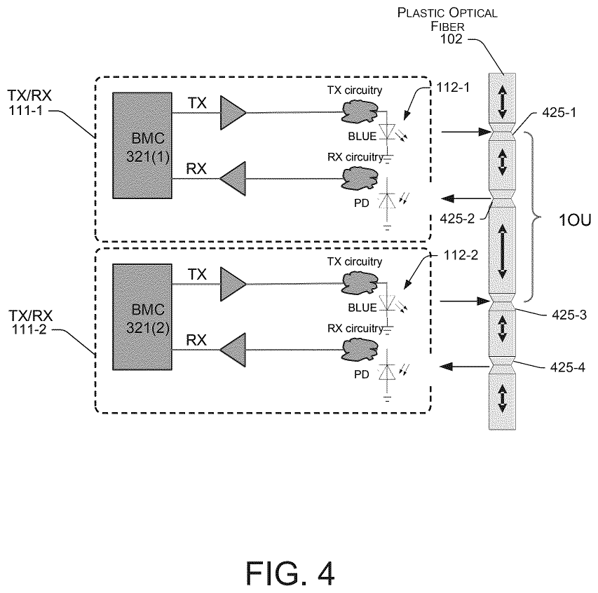

FIG. 4 illustrates an example of node-to-node communication, according to at least one embodiment of the present disclosure. In an embodiment, a particular component or node may be associated with at least two repurposed, two blue colored-system ID LEDs for full-duplex communication. In some embodiments, the component or node may utilize a photodiode instead of using a second repurposed blue colored-system ID LED to detect the modulated light signals. Here, the BMC, such as BMCs 321(1)-321(2) in respective TX/RX 111(1)-111(2), may be reconfigured to manage the new capabilities of the repurposed blue-colored system ID LEDs.

For example, the TX/RX 111(1) utilizes the system LED 112-1 that includes a separate repurposed blue colored-system ID LED with photodiode capabilities for transmission and reception of data. Here, the first repurposed blue colored-system ID LED can be used for transmission, while the second repurposed blue colored-system ID LED can be used to detect and receive data. Further, the first and second repurposed blue colored-system ID LEDs with photodiode capabilities may be optically coupled to the PMMA plastic optical fiber 102 via a notch 425-1 and notch 425-2, respectively. In some embodiments, a photodiode may replace the second repurposed blue colored-system ID LED to detect the modulated light signals.

In another example, the TX/RX 111(s) utilizes the system LED 112-2 that includes a separate repurposed blue colored system ID LEDs with photodiode capabilities for transmission and reception of data. Here, the third repurposed blue colored system ID LED can be used for transmission, while the fourth repurposed blue colored system ID LED can be used to detect and receive data. In some cases, a photodiode may replace the fourth repurposed blue colored-system ID LED to detect the modulated light signals. The third and fourth repurposed blue colored-system ID LEDs may be optically coupled to the PMMA plastic optical fiber 102 via a notch 425-3 and notch 425-4, respectively. In some embodiments, the distance between the notch 425-1 and the notch 425-3, which are exclusively used for data transmissions, is 1OU. Further, the distance between the notch 425-2 and the notch 425-4, which are exclusively used for receiving data, is also 1OU.

In some embodiments, the plastic optical fiber 102 is dedicated for the nodes that support full-duplex communication only. Here, and depending upon the physical location of these nodes in the ORv3 structure, the predetermined intervals between the notch 425-1 and the notch 425-3 can be more or less than 1OU.

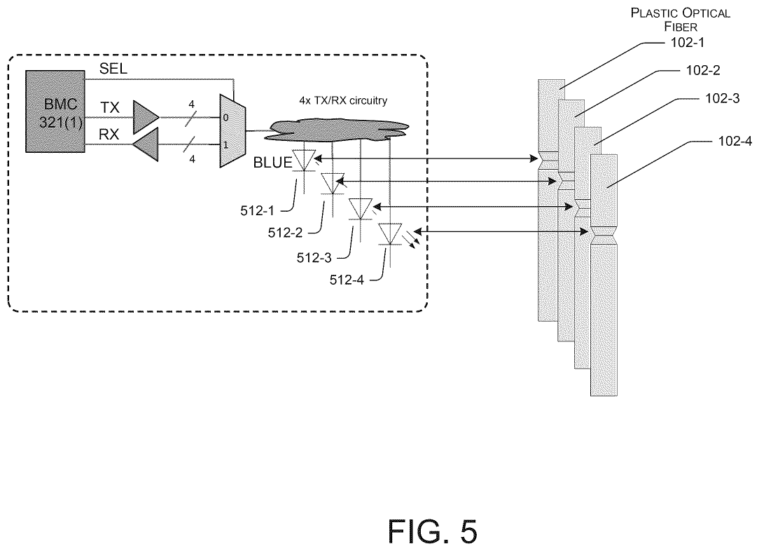

FIG. 5 illustrates an example of node-to-node communication, according to at least one embodiment of the present disclosure. In an embodiment, four separate blue colored-system ID LEDs in a particular node (e.g., component 110(1)) can be repurposed to form system LEDs 512-1 to 512-4, respectively. In this embodiment, each of the system LEDs 512-1 to 512-4 may be configured to communicatively couple with dedicated PMMA plastic optical fibers 102-1 to 102-4, respectively. The use of the four parallel plastic optical fibers may allow independent data transmission channels to support, for example, transmitting or receiving of four bits of data simultaneously. Here, the BMC 321(1) may be reconfigured to support synchronization of the parallel transmission or reception of multiple bits. Further, the BMC may be reconfigured to support independent modulation schemes corresponding to the type of system LEDs used in each of the parallel plastic optical fibers.

For example, the BMC 321(1) may use the PMMA plastic optical fibers 102-1 to 102-4 to transmit or receive 4 bits in parallel. Here, the BMC 321(1) may assign a different wavelength or color spectrum to each of the dedicated plastic optical fibers. The different wavelengths or color spectrums may facilitate wavelength division multiplexing (WDM) within each of the PMMA plastic optical fibers 102-1 to 102-4 to implement simultaneous parallel data transmission.

In some embodiments, the different dedicated plastic optical fibers may support a corresponding type of repurposed OLS or system ID LEDs. For example, the plastic optical fiber 102-1 supports the blue colored-system ID LEDs that are effective in rejecting ambient light and can be used to transmit modulated light signals; the second plastic optical fiber 102-2 supports high-intensity LEDs that emit stronger light signals and can be used for transmitting data over longer distances with minimal losses; the third plastic optical fiber 102-3 supports ultraviolet (UV) LEDs that can emit higher energy at a shorter wavelength, which can be useful for precise transmission or reception of data; and the fourth plastic optical fiber 102-4 supports laser diodes that can be used for high-data-rate transmission due to their more focused and coherent light. These dedicated plastic optical fibers are predetermined based on the desired communication requirements, such as data rate, distance, security, or presence of high ambient light conditions. In this example, the BMC 321(1) may be reconfigured to support the different configurations for transmission and reception of data by these dedicated PMMA plastic optical fibers.

FIG. 6 is a diagram of an example data transmission 629 between a transmitting node-component 110(1) and a receiving node-component 110(2) according to at least one embodiment of the present disclosure. As shown, the data transmission 629 may include the steps of encoding 631 of original data 630, a transmitting 632 of the encoded data, using the optical bus system 101 as channel 633, receiving 634 of the modulated light rays 120(1) by the receiving node, color correcting 635 of the received modulated light rays 120(1) to compensate for the optical bus system light attenuation, quantizing 636 of the corrected RGB values, decoding 637 of the quantized RGB values, and receiving 638 of the original data 630. In some embodiments, the data transmission 629 may further include applying 639 of a PN sequence 640 that is assigned to the transmitting node-component 110(1) to spread the light rays 120(1) across a wider frequency band and applying 641 of the same PN sequence 640 by the receiving node-component 110(2) to despread the light rays 120(1) that is representative of the modulated signal. The assignment of the different PN sequences to different nodes may facilitate simultaneous transmission and reception of modulated light signals using the shared channel 633.

PN sequence 640 may include a pseudo-random binary sequence that can be used to modulate a timing or phase of a data signal, such as the PWM signal, to generate a spread spectrum signal. For example, a PWM technique is used to encode the data 630 and generate a PWM signal with varying duty cycles. Here, the pseudo-random binary sequence may be applied to the timing or pulses of the PWM signal to spread the data signal across a wider spectrum. The PN sequence 640 itself does not carry the actual data, but the application may provide interference resistance and security to the data signal. In some embodiments, the assigned PN sequence 640 may act as a node address or identifier of the component 110(1) to distinguish the data that are being transmitted from this node.

In an embodiment, an RGB LED (system LED 112(1)) of the transmitting node—component 110(1) may be repurposed to generate different combinations of red, green, and blue intensities to represent different data values. Here, the component 110(1) controller may utilize the different combination of intensities from the red, green, and blue LEDs to represent the data to be transmitted over the channel 633. The data to be transmitted may include a particular number of bits for the actual data and additional number error correction bits to detect and correct the errors that may be generated by attenuation in the channel 633.

For example, an M number of bits may represent the actual data, and an N number of error correction bits may be added to have a total of M+N bits for the original data 630. Here, the N bits of error correction bits are added to the M bits of original data to allow the receiving node to detect and correct the errors that may occur during transmission. In this example, the component 110(1) controller may utilize a PWM technique to vary the intensities (or duty cycle) of the RGB LEDs to encode the M+N bits of data and generate the data signal. The controller may use 2^{M+N} distinct intensities or color combinations to represent different distinct values of data to be encoded.

Following the example above, which utilizes the PWM technique on the RGB LEDs to encode 2^{M+N} symbols (each symbol includes M+N bits), applying 639 of the assigned PN sequence 640 on the data signal (or PWM pulses) may spread the data signal across the wider frequency band. Applying 639 of the assigned PN sequence 640 may generate the spread spectrum signal (or modulated signal) from data signal. The application of the PN sequence 640 may provide interference resistance and enable multiple signals to share the same communication channel 633. The light rays 120 as shown may be representative of the PN sequence modulated PWM pulses (i.e., spread spectrum signal or modulated signal) that are being transmitted across a wide frequency band or spread spectrum.

Upon receiving 634 of the light rays 120, the receiving node—component 110(2) may implement the applying 641 of the assigned PN sequence 640 to despread the modulated light rays 120. The receiving node and the other nodes in the node-to-node communication system are preconfigured to store the assigned node PN sequences. By performing a correlation of PN sequences, the receiving node—component 110(2) may determine the assigned PN sequence of the transmitting node—component 110(1).

The receiving node-component 110(2) may then apply the determined PN sequence 640 of the transmitting node to detect and despread the detected modulated signal to data signal form (i.e., PWM signal). The data signal includes the state prior to application of the PN sequence 640 to the PWM pulses to generate the spread spectrum signal or modulated signal. The receiving node may further perform color correcting 635 on the despread data signal to correct the signal attenuation or noise that can be caused by the optical bus system 101. For example, the receiving node may apply a calibration matrix (K) to adjust the received intensities to their desired values. The color correcting 635 is further described in FIG. 7 below.

The receiving node may then perform quantizing 636 of the corrected intensities to map the continuous values of the corrected intensities to discrete binary values (bits). The receiving node may perform the decoding 637 to recover the M+N bits of data as shown at receiving 638 of the original data.

FIG. 7 is an example color correcting process according to at least one embodiment of the present disclosure. The color correcting process, such as the color correcting 635 in FIG. 6, may include compensating for signal attenuation and color distortion that may occur when transmitting data through the channel 633. The structure of the channel 633, such as the optical bus system 101 in FIG. 1 may attenuate the modulated light signals that travel through the plastic optical fiber 102, causing a decrease in signal strength. For example, the red, green, and blue light intensities may experience different levels of attenuation since different color wavelengths attenuate differently in the plastic optical fiber 102. This attenuation may be further caused by mechanical misalignment between the notches and the repurposed RGB LEDs.

In some embodiments, the information handling system may perform a calibration sequence to find the calibration matrix (K) that is representative of the plastic optical fiber distortion characteristics. For example, the calibration sequence may include driving the Red (R) light of the RGB LED to 100% duty cycle. The received signal is recorded as RGBᵣ and attenuation values Kn1 can be derived directly from for the red channel. The same process is repeated on the Green (G) light and the Blue (B) light of the RGB LED to derive the Kn2 and Kn3 values, respectively.

In an embodiment, the color distortion for the RGB LED can be described by a matrix multiplication, where K is a set of constants for each plastic optical fiber type and length. For example, equation 745 shows the relationship between the transmitted signal RGB_{T} (original signal sent through the plastic optical fiber) and the received signal RGB_{R} (distorted modulated signal traveling through the plastic optical fiber). Here, the RGB_{T} is a vector that is representative of the transmitted intensities of the Red (Rt), Green (Gt), and Blue (Bt) light signals; RGB_{R} is a vector representing the received intensities of Red (Rr), Green (Gr), and Blue (Br) light signals after distortion; and K is the calibration matrix that represents the plastic optical fiber's distortion characteristics as described in the calibration process above.

To correct the color distortion, equation 746 shows the application of the inverse of the calibration matrix (K) to the received RGB values to calculate the original transmitted signal, RGB_{T}. The corrected signal is then calculated using an equation 747 where RGB_{CORRECTED} is equal to a product of the inverse of the calibration matrix (K) and the RGB_{ORIGINAL}. The RGB_{CORRECTED} is representative of the corrected RGB signal that substantially matches the original transmitted RGB values.

During normal operation, the node controller may continuously use the K⁻¹ matrix to correct the received RGB values and provide accurate data transmission. Each of the components 110(1)-110(5) may run this correction process to compensate for the attenuation that may be caused by the fiber length or mechanical misalignment.

In an embodiment, the receiving node such as the component 110(2) in FIG. 6 may apply calibration matrix (K) to adjust the received intensities of the despread light rays 120(1).

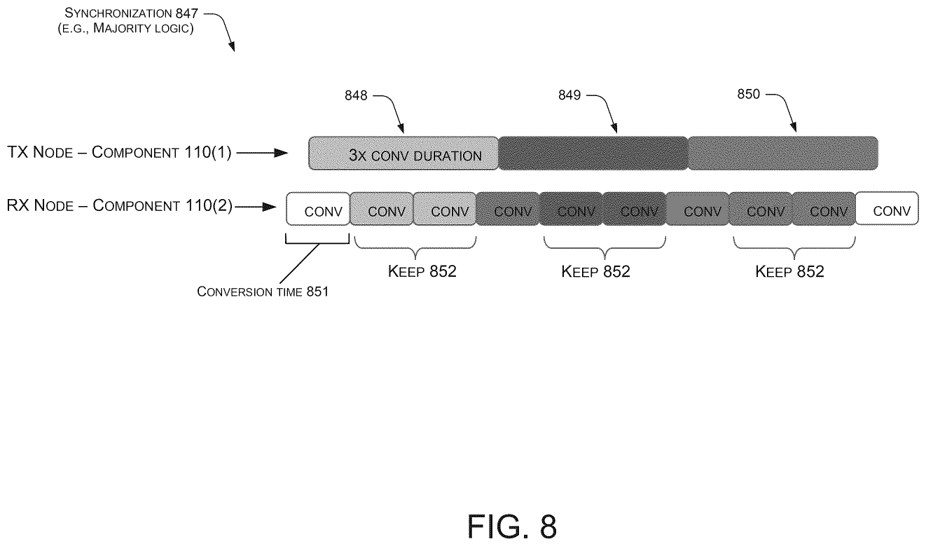

FIG. 8 is an example synchronization 847 to align the receiving (RX) node with the transmitting (TX) node in a node-to-node communication according to at least one embodiment of the present disclosure. The synchronization 847 may compensate for timing errors or misalignments that can affect the reliability of data transmission in the optical bus system as described herein.

In an embodiment, the synchronization 847, such as a majority logic type of synchronization, may determine the correct symbol based on multiple readings. For example, the transmitting node component 110(1) transmits each symbol for a duration that is equal to 3 times the conversion time. Here, the conversion time may include the time to completely transmit or process one symbol. In this example, the extended symbol transmission duration may provide the receiving node component 110(2) multiple opportunities to read the transmitted symbol.

For example, as shown, the duration of each of blue signal 848, red signal 849, and green signal 850 is about three times the length of a conversion time 851 at the receiving node—component 110(2). Here, the receiving node component 110(2) may keep 852 the read symbol (appeared 2×) as the correct symbol and disregard the outlier symbol (appeared 1×).

In an alternative embodiment, the synchronization 847 may also utilize a software Phase-Locked Loop (PLL) (not shown) to dynamically synchronize the receiver node's clock with the transmitting node's clock. For example, the transmitting node component 110(1) transmits preamble symbols with a duration of 3 times the conversion time 851 as described above. The preamble symbols may be used to lock the receiver's timing relative to the transmitter's timing. The extended duration to send the preamble symbol may give the receiver more time to synchronize. Here, the receiving node—component 110(2) compares three consecutive readings of the preamble symbol and adjusts its internal clock until all three readings are equal. This process ensures that the receiver is aligned with the transmitter's timing. Once synchronized, the transmitting node switches to transmitting of the symbols for the same time (1×) as the conversion time. The transmission of the symbols at this duration may require higher bit rage because each symbol is being transmitted in a shorter period.

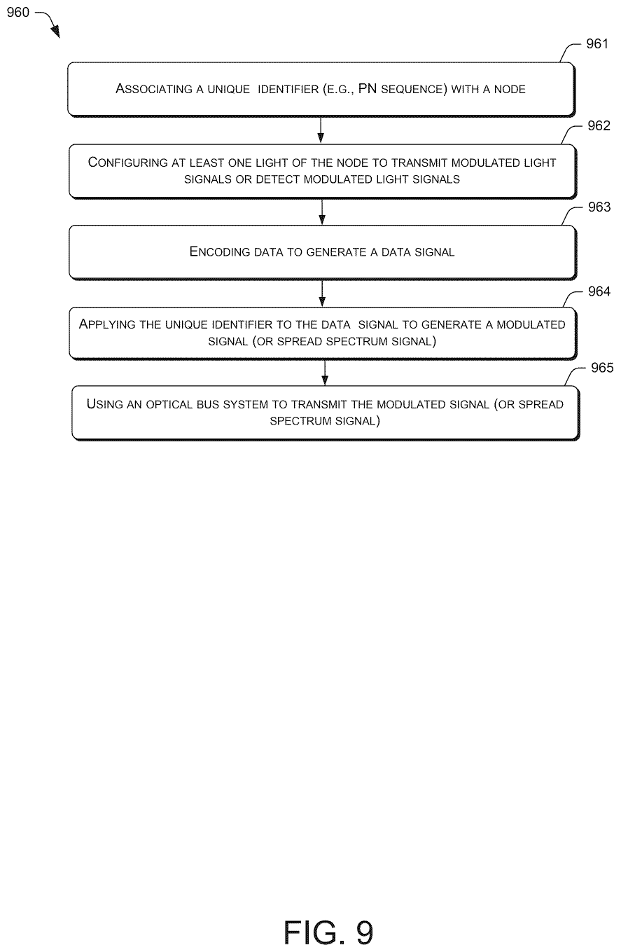

FIG. 9 is a flow diagram of a method 960 for data transmission in node-to-node communication according to at least one embodiment of the present disclosure, starting at step 961. It will be readily appreciated that not every method step set forth in this flow diagram is always necessary, and that certain steps of the methods may be combined, performed simultaneously, in a different order, or perhaps omitted, without varying from the scope of the disclosure. FIGS. 1-2 may be employed in whole, or in part, by a TX/RX controller of the information handling system 100 of FIG. 1, or any other type of controller, device, module, processor, or any combination thereof, operable to employ all, or portions of, the method of FIG. 9.

At step 961, the controller may associate a unique identifier with a node. For example, different PN sequences are assigned to the components 110(1)-110(5) of the information handling system 100. Here, the nodes may be preconfigured to be associated with corresponding distinct PN sequences. The assigned PN sequences may be used as corresponding addresses or identifiers of the nodes.

In some embodiments, the assigned PN sequence that may be used as the unique identifier is selected to have a low cross-correlation with the other PN sequences assigned to other nodes to enable multiple nodes to transmit data simultaneously using Code Division Multiple Access (CDMA) techniques.

At step 962, the controller may configure at least one light of the node to transmit modulated light signals or detect modulated light signals. For example, the controller of the component 110(1) may repurpose the OLS or system ID LEDs to generate different light signals with different intensities to represent modulating data.

At step 963, the controller may encode data to generate a data signal. For example, the encoding may use a PWM technique to generate the PWM signal, which is also referred to herein as the data signal.

At step 964, the controller may apply the unique identifier to the data signal to generate a modulated signal or spread spectrum signal. For example, the assigned PN sequence is applied to the data signal to spread the data signal across a wider frequency band. Here, the spread data signal is referred to as the spread spectrum signal.

At step 965, the controller may use the optical bus system to transmit the modulated signal (or spread spectrum signal).

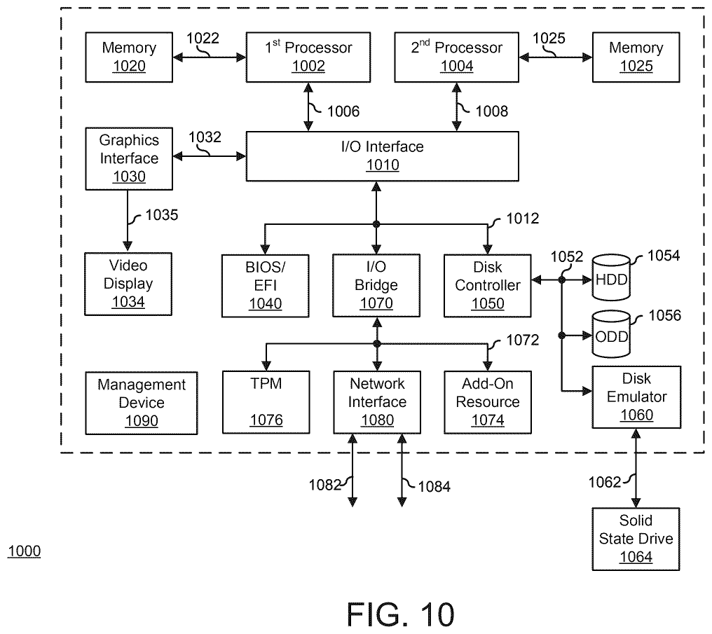

FIG. 10 shows a generalized embodiment of an information handling system 1000 according to an embodiment of the present disclosure. Information handling system 1000 may be substantially similar to information handling system 100 of FIG. 1. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 1000 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 1000 can include processing resources for executing machine-executable code, such as a central processing unit (CPU), a programmable logic array (PLA), an embedded device such as a System-on-a-Chip (SoC), or other control logic hardware. Information handling system 1000 can also include one or more computer-readable medium for storing machine-executable code, such as software or data. Additional components of information handling system 1000 can include one or more storage devices that can store machine-executable code, one or more communications ports for communicating with external devices, and various input and output (I/O) devices, such as a keyboard, a mouse, and a video display. Information handling system 1000 can also include one or more buses operable to transmit information between the various hardware components.

Information handling system 1000 can include devices or modules that embody one or more of the devices or modules described below and operate to perform one or more of the methods described below. Information handling system 1000 includes a processors 1002 and 1004, an input/output (I/O) interface 1010, memories 1020 and 1025, a graphics interface 1030, a basic input and output system/universal extensible firmware interface (BIOS/UEFI) module 1040, a disk controller 1050, a hard disk drive (HDD) 1054, an optical disk drive (ODD) 1056, a disk emulator 1060 connected to an external solid state drive (SSD) 1064, an I/O bridge 1070, one or more add-on resources 1074, a trusted platform module (TPM) 1076, a network interface 1080, a management device 1090, and a power supply 1095. Processors 1002 and 1004, I/O interface 1010, memory 1020, graphics interface 1030, BIOS/UEFI module 1040, disk controller 1050, HDD 1054, ODD 1056, disk emulator 1060, SSD 1064, I/O bridge 1070, add-on resources 1064, TPM 1076, and network interface 1080 operate together to provide a host environment of information handling system 1000 that operates to provide the data processing functionality of the information handling system. The host environment operates to execute machine-executable code, including platform BIOS/UEFI code, device firmware, operating system code, applications, programs, and the like, to perform the data processing tasks associated with information handling system 1000.

In the host environment, processor 1002 is connected to I/O interface 1010 via processor interface 1006, and processor 1004 is connected to the I/O interface via processor interface 1008. Memory 1020 is connected to processor 1002 via a memory interface 1022. Memory 1025 is connected to processor 1004 via a memory interface 1027. Graphics interface 1030 is connected to I/O interface 1010 via a graphics interface 1032 and provides a video display output 1036 to a video display 1034. In a particular embodiment, information handling system 1000 includes separate memories that are dedicated to each of processors 1002 and 1004 via separate memory interfaces. An example of memories 1020 and 1030 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 1040, disk controller 1050, and I/O bridge 1070 are connected to I/O interface 1010 via an I/O channel 1012. An example of I/O channel 1012 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 1010 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 1040 includes BIOS/UEFI code operable to detect resources within information handling system 1000, to provide drivers for the resources, initialize the resources, and access the resources. BIOS/UEFI module 1040 includes code that operates to detect resources within information handling system 1000, to provide drivers for the resources, to initialize the resources, and to access the resources.

Disk controller 1050 includes a disk interface 1052 that connects the disk controller to HDD 1054, to ODD 1056, and to disk emulator 1060. An example of disk interface 1052 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 1060 permits SSD 1064 to be connected to information handling system 1000 via an external interface 1062. An example of external interface 1062 includes a USB interface, an IEEE 4394 (Firewire) interface, a proprietary interface, or a combination thereof. Alternatively, solid-state drive 1064 can be disposed within information handling system 1000.

I/O bridge 1070 includes a peripheral interface 1072 that connects the I/O bridge to add-on resource 1074, to TPM 1076, and to network interface 1080. Peripheral interface 1072 can be the same type of interface as I/O channel 1012 or can be a different type of interface. As such, I/O bridge 1070 extends the capacity of I/O channel 1012 when peripheral interface 1072 and the I/O channel are of the same type, and the I/O bridge translates information from a format suitable to the I/O channel to a format suitable to the peripheral channel 1072 when they are of a different type. Add-on resource 1074 can include a data storage system, an additional graphics interface, a network interface card (NIC), a sound/video processing card, another add-on resource, or a combination thereof. Add-on resource 1074 can be on a main circuit board, on separate circuit board or add-in card disposed within information handling system 1000, a device that is external to the information handling system, or a combination thereof.

Network interface 1080 represents a NIC disposed within information handling system 1000, on a main circuit board of the information handling system, integrated onto another component such as I/O interface 1010, in another suitable location, or a combination thereof. Network interface device 1080 includes network channels 1082 and 1084 that provide interfaces to devices that are external to information handling system 1000. In a particular embodiment, network channels 1082 and 1084 are of a different type than peripheral channel 1072 and network interface 1080 translates information from a format suitable to the peripheral channel to a format suitable to external devices. An example of network channels 1082 and 1084 includes InfiniBand channels, Fibre Channel channels, Gigabit Ethernet channels, proprietary channel architectures, or a combination thereof. Network channels 1082 and 1084 can be connected to external network resources (not illustrated). The network resource can include another information handling system, a data storage system, another network, a grid management system, another suitable resource, or a combination thereof.

Management device 1090 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 1000. In particular, management device 1090 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 1000, such as system cooling fans and power supplies. Management device 1090 can include a network connection to an external management system, and the management device can communicate with the management system to report status information for information handling system 1000, to receive BIOS/UEFI or system firmware updates, or to perform other task for managing and controlling the operation of information handling system 1000.

Management device 1090 can operate off of a separate power plane from the components of the host environment so that the management device receives power to manage information handling system 1000 when the information handling system is otherwise shut down. An example of management device 1090 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 1090 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An optical bus system, comprising:
a plastic optical fiber configured to transmit light signals between a plurality of nodes, wherein the plastic optical fiber further comprises:
a plurality of molded notches positioned at first predetermined intervals along a length of the plastic optical fiber, wherein each of the plurality of molded notches is configured to allow a light ingress into and a light egress from the plastic optical fiber; and
a shield enclosing the plastic optical fiber, wherein the shield further comprises:
a plurality of shield openings positioned at second predetermined intervals along a length of the shield, wherein the shield openings are aligned with corresponding molded notches to allow the light ingress into and the light egress from the plastic optical fiber.

2. The optical bus system of claim 1, wherein a predetermined interval between adjacent molded notches that are used for half-duplex communication is set at 1OU.

3. The optical bus system of claim 1, wherein multiple plastic optical fibers are configured to act as independent channels in transmitting multiple bits in parallel.

4. The optical bus system of claim 3, wherein each of the multiple plastic optical fibers is assigned to a different wavelength or color spectrum to facilitate wavelength division multiplexing (WDM) in each of the multiple plastic optical fibers for simultaneous parallel data transmission.

5. The optical bus system of claim 1, wherein at least two molded notches are assigned to a single node for a full-duplex communication.

6. The optical bus system of claim 5, wherein a first molded notch is dedicated for transmitting data while a second molded notch is dedicated for receiving data.

7. The optical bus system of claim 1, wherein the shield is made of an opaque material configured to prevent ambient light from entering the plastic optical fiber.

8. The optical bus system of claim 1, wherein a diameter of each of the plurality of shield openings is configured to be at least equal to the diameter of the plastic optical fiber.

9. The optical bus system of claim 1, wherein each of the shield openings is shaped as a circular aperture that is aligned with corresponding molded notches on the plastic optical fiber.

10. The optical bus system of claim 1, wherein each of the molded notches is shaped as a lens.

11. An information handling system comprising:
a plurality of nodes; and
an optical bus system, further comprising:
a plastic optical fiber configured to transmit light signals between the plurality of nodes, wherein the plastic optical fiber further comprises:
a plurality of molded notches positioned at first predetermined intervals along a length of the plastic optical fiber, wherein each of the plurality of molded notches is configured to allow a light ingress into and a light egress from the plastic optical fiber for node-to-node communication; and
a shield enclosing the plastic optical fiber, wherein the shield further comprises:
a plurality of shield openings positioned that at second predetermined intervals along a length of the shield, wherein the shield openings are aligned with corresponding molded notches to allow the light ingress and the light egress.

12. The information handling system of claim 11, wherein a predetermined interval between adjacent molded notches that are used for half-duplex communication is set at 1OU.

13. The information handling system of claim 11, wherein multiple plastic optical fibers are configured to act as independent channels in transmitting multiple bits in parallel.

14. The information handling system of claim 13, wherein each of the multiple plastic optical fibers is assigned to a different wavelength or color spectrum to facilitate wavelength division multiplexing (WDM) in each of the multiple plastic optical fibers for simultaneous parallel data transmission.

15. The information handling system of claim 11, wherein at least two molded notches are assigned to a single node for a full-duplex communication.

16. The information handling system of claim 15, wherein a first molded notch is dedicated for transmitting data while a second molded notch is dedicated for receiving data.

17. The information handling system of claim 11, wherein the shield is made of an opaque material configured to prevent ambient light from entering the plastic optical fiber.

18. An optical bus system, comprising:
a plastic optical fiber configured to transmit light signals between a plurality of nodes, wherein the plastic optical fiber further comprises:
a plurality of molded notches positioned at predetermined intervals along a length of the plastic optical fiber, wherein each of the plurality of molded notches is configured to allow a light ingress into and a light egress from the plastic optical fiber for node-to-node communication.

19. The optical bus system of claim 18 further comprising: a shield that includes a plurality of shield openings positioned that at predetermined intervals along a length of the shield, wherein the shield openings are aligned with corresponding molded notches to allow the light ingress and egress.

20. The optical bus system of claim 19, wherein a diameter of each of the plurality of shield openings is configured to be at least equal to the diameter of the plastic optical fiber.
